(19) United States
(12) Patent Application Publication
(10) Pub. No.: US 2017/0071176 A1
(43) Pub. Date: Mar. 16, 2017

(54) Fish Hook System

(71) Applicant: Wade Duffield, Calgary (CA)

(72) Inventor: Wade Duffield, Calgary (CA)

(21) Appl. No.: 14/850,724

(22) Filed: Sep. 10, 2015

(51) Int. Cl. A01K 83/06; A01K 83/04

(52) U.S. Cl. CPC A01K 83/06; A01K 83/04

(57) ABSTRACT

A fish hook system includes a central connecting rod having an eyelet constructed and arranged for receiving a fishing line, a first hook, a second hook having a connecting eyelet constructed and arranged to said connecting rod, whereby said second hook is constructed and arranged to pass through a connecting eyelet of said first hook.

### BACKGROUND OF THE INVENTION

Fishing enthusiasts are continually trying to develop and improve the various implements used in their craft. However, the basic fishing hook still has several limitations. One limitation includes producing a desirable in-water motion to attract fish. The single fishing hook is unable to do this. The present invention has discovered a configuration whereby a dual fishing hook system effectively attracts and hooks fish.

### SUMMARY OF THE INVENTION

In one embodiment, the fish hook system of the present invention holds bait in a horizontal position, secure between the 2 hooks. This displays the bait in a more natural way, and reduces the possibility of the bait slipping off the hook.

The hook system of the present invention has the following advantages:

No more floppy bait;

More control;

Greater potential of developing realistic looking artificial bait to fit double-hook system;

Multiple hooking points increases chance of catching fish; Makes natural bait (strip herring, etc.) look lifelike by holding it in a horizontal position (as in FIGS. 2 and 3).

In one embodiment, the present invention is a fish hook system comprising: a central connecting rod having an eyelet on a first end and curved support on a second end constructed and arranged for receiving a fishing line; a first hook; a second hook having a connecting eyelet constructed and arranged to said connecting rod, whereby said second hook is constructed and arranged to pass through a connecting eyelet of said first hook.

In one embodiment the system is configured to hold bait that is positioned in an angular configuration relative to said central connecting rod.

In one embodiment the system is configured to hold bait that is positioned in an angular configuration relative to said central connecting rod, said angle between about 45-90 degrees.

In one embodiment the system is configured to hold bait that is positioned in an angular configuration relative to said central connecting rod, said angle between about 75-90 degrees.

In one embodiment the second hook eyelet is constructed and arranged to move along the length of said connecting rod.

In one embodiment the second hook eyelet is constructed and arranged to move along the length of said connecting rod and secure into a fixed position.

### BRIEF DESCRIPTION OF THE SEVERAL VIEWS OF THE DRAWING

FIG. 1 is a perspective view of the fish hook system according to one embodiment of the present invention.

FIG. 2 is a side partial cross section view demonstrating a fish hooked according to one embodiment of the present invention.

FIG. 3 is a side view demonstrating a fish hooked according to one embodiment of the present invention.

### DETAILED DESCRIPTION OF THE PREFERRED EMBODIMENT

The present invention relates to a novel fish hook system 10 that is generally understood to be configurable with a first hook 12 and a second hook 14. In one embodiment, either first hook 12 or second hook 14 can be barbed. The invention is configured that each of first hook 12 and second hook 14 can be barbed, only one can be barbed, or both can be barbless. It is further contemplated that bait, not shown, is incorporated as desired on either first hook 12 alone, first hook 12 and second hook 14, or only second hook 14. Additionally, a weight or float can be attached to either first hook 12, second hook 14, along connecting rod 16, or in combinations thereof. Connecting rod 16 is constructed and arranged to secure to fishing line 18. In one embodiment, securing is only through connecting rod 16. In another embodiment, fishing line 18 is secured to system 10 through either the eyelet 22 of first hook 12, the eyelet 28 of second hook 14, or in any combinations thereof.

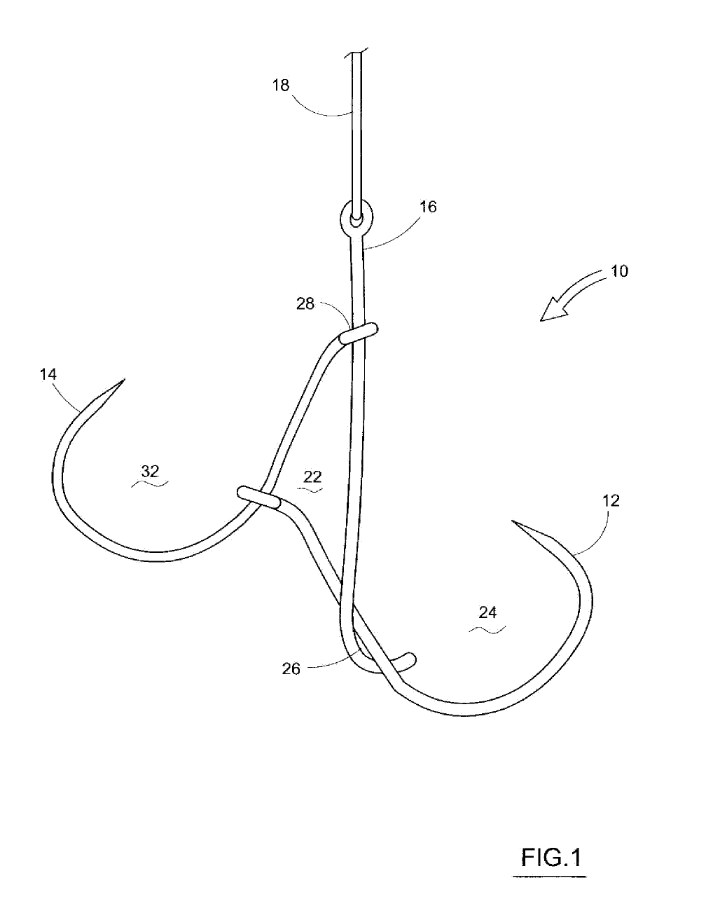

System 10 is constructed and arranged to have a first area of separation between connecting rod 16 and second hook 14, a second area of separation formed within the hook configuration of first hook 12, and a third area of separation 32 formed within second hook 14. Connecting rod 16 has a first eyelet end for connecting with fishing line 18 as demonstrated each of FIGS. 1, 2 and 3, and connecting rod 16 further has a terminal positioning curvature 26 in use in system 10.

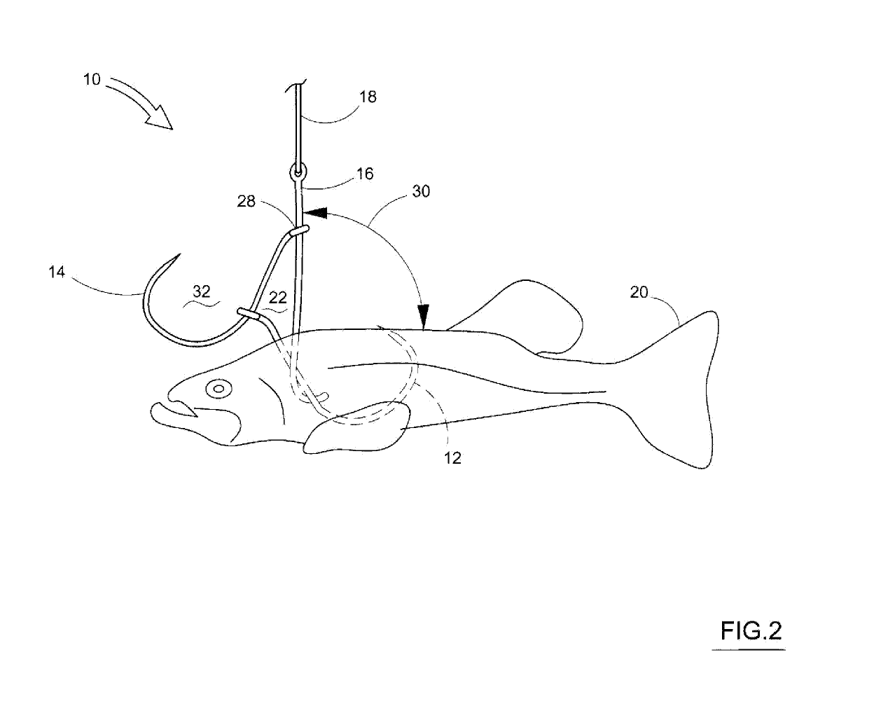

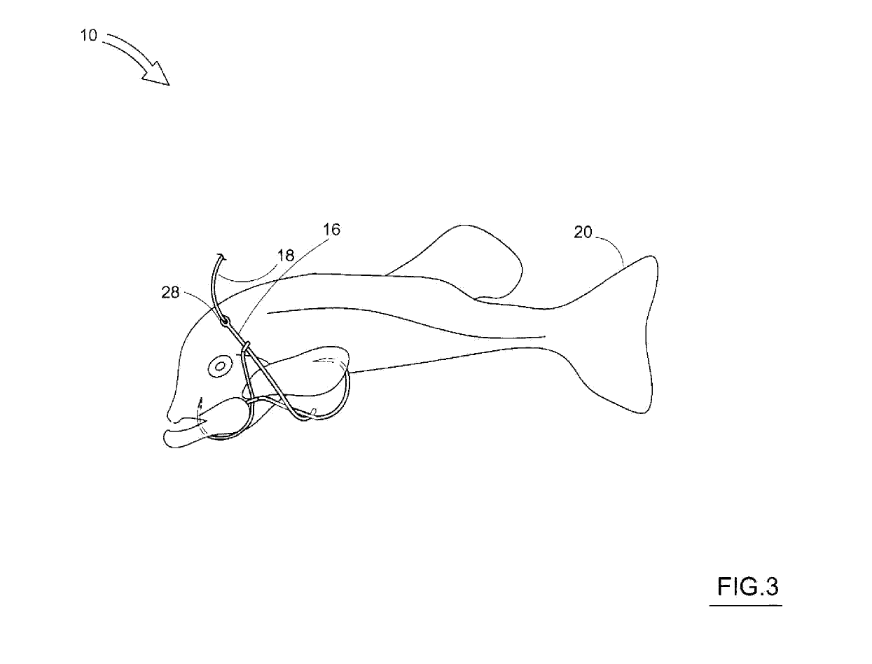

In one embodiment, as demonstrated in FIG. 2, angle 30 represents an optimum angle for relative placement of bait to connecting rod 16. In one embodiment, angle 30 is preferably an angle between 45 and 90 degrees. In another embodiment, angle 30 represents an angle between 70 and 90 degrees. In a preferred embodiment, the bait is positioned 90 degrees relative to connecting rod 16. In one embodiment, as demonstrated in Fig.2, fish 20 is hooked on first hook 12. In another embodiment, as demonstrated in FIG. 3, fish 20 is hooked on each of first hook 12 and second hook 14.

It is generally understood that first hook 12 and second hook 14 have relative ranges of motion in order to move independently and said independent motions be more attractive to fish.

Although the figures show an embodiment, of two hooks, other embodiments are contemplated that include more than two hooks.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention

What is claimed is:

1. A fish hook system comprising: a central connecting rod having an eyelet constructed and arranged for receiving a fishing line; a first hook; a second hook having a connecting eyelet constructed and arranged to said connecting rod, whereby said second hook is constructed and arranged to pass through a connecting eyelet of said first hook.

2. The system of claim 1 wherein bait is positioned in an angular configuration relative to said central connecting rod.

3. The system of claim 1 wherein bait is positioned in an angular configuration relative to said central connecting rod, said angle between about 45-90 degrees.

4. The system of claim 1 wherein bait is positioned in an angular configuration relative to said central connecting rod, said angle between about 75-90 degrees.

5. The system of claim 1 wherein said second hook eyelet is constructed and arranged to move along the length of said connecting rod.

6. The system of claim 1 wherein said second hook eyelet is constructed and arranged to move along the length of said connecting rod and secure into a fixed position.
